(19) United States
(12) Patent Application Publication
(10) Pub. No.: US 2019/0353787 A1
(43) Pub. Date: Nov. 21, 2019

(54) Coded Laser Light Pulse Sequences for LIDAR

(71) Applicant: Blickfeld GmbH, Munich (DE)

(72) Inventor: Florian Petit, Munich (DE)

(21) Appl. No.: 16/334,209

(22) PCT Filed: Sep. 19, 2017
(86) PCT No.: PCT/EP2017/073574

§ 371 Date: Jul. 30, 2019

(30) Foreign Application Priority Data
Sep. 19, 2016 (DE) 10 2016 011 299.9

(51) Int. Cl. G01S 17/10; G01S 7/481; G01S 7/484; G01S 17/89; G01S 17/93

(52) U.S. Cl. CPC G01S 17/10; G01S 7/4815; G01S 7/4817; G01S 17/102; G01S 17/89; G01S 17/936; G01S 7/4818; G01S 7/484

(57) ABSTRACT

A LIDAR system comprising at least one laser light source and a detector is configured to transmit a first coded pulse train and a second coded pulse train. An image point of a LIDAR image is determined based on the first pulse train and the second pulse train. CDMA techniques can be used in order to recognize the pulse trains in the measurement signals of the detector.

### TECHNICAL FIELD

Different examples of the invention relate to a device with a computation unit which is configured to recognize a first pulse train and a second pulse train of laser light, in order to obtain an associated distance value of an object in the surroundings. Some examples relate to LIDAR techniques.

### BACKGROUND

The distance measurement of objects is desirable in different technology fields. For example, in connection with autonomous driving applications, it can be desirable to recognize objects in the environment of vehicles and in particular to detect a distance to the objects.

A technique for distance measurement of objects is the so-called LIDAR technology (English Light detection and ranging; sometimes also LADAR). Here, pulsed laser light is emitted by an emitter. The objects in the environment reflect the laser light. These reflections can subsequently be measured. By the determination of the transit time of the laser light, a distance to the objects can be determined.

In order to recognize the objects in the environment with spatial resolution, it can be possible to scan the laser light. Depending on the angle of radiation of the laser light, different objects in the surroundings can thereby be recognized.

In some application cases, LIDAR techniques are used in vehicles, for example, in private cars. In this way, for example, autonomous driving techniques can be implemented. In general, different driver assistance functionalities based on LIDAR data with distance or depth information are conceivable.

In the application in street traffic or in general in surroundings with people, it can be necessary to comply with certain requirements of eye safety. Therefore, the power of the laser light can be limited. In addition, it can be necessary to use particularly small and cost effective laser light sources, for example, solid state laser diodes. For this reason as well, the power of the laser light can be limited. In addition, significant background radiation can exist, for example, due to a low sun, etc.

Since the power of the laser light is often limited, the intensity of the reflected laser light can decrease considerably in the case of objects in the surroundings located farther away. Therefore, the distance at which objects in the surroundings can still be measured based on LIDAR techniques (measurement distance) can be limited, for example, can be in the range of 100-300 m.

On the other hand, in connection with driver assistance functionalities at high speeds, it can be desirable to provide a particularly large measurement distance.

For example, from KIM, Gunzung; EOM, Jeongsook; PARK, Yongwan. A hybrid 3D LIDAR imager based on pixel-by-pixel scanning and DS-OCDMA, in: SPIE OPTO. International Society for Optics and Photonics, 2016. pp. 975119-975119-8, theoretical considerations are known for using in each case a uniquely coded pulse train for each image point of a LIDAR image. However, such techniques require particularly long pulse trains and they do not make it possible to increase the measurement distance.

### BRIEF SUMMARY OF THE INVENTION

Therefore, a need exists for improved techniques for measuring the distance of objects based on laser light. In particular, a need exists for techniques that reduce or eliminate some of the above-mentioned limitations and disadvantages.

This aim is achieved by the features of the independent claims. The dependent claims define embodiments. In an example, a device comprises a laser scanner. The laser scanner comprises at least one laser light source and a detector. The laser scanner is configured to transmit laser light into different angular zones. Moreover, the laser scanner is configured to detect reflected laser light. The device also comprises a computation unit which is configured to actuate the laser scanner, to transmit a first coded pulse train of the laser light and to transmit at least one second coded pulse train of the laser light. The computation unit is moreover configured to recognize the first pulse train in measurement signals of the detector and to obtain in this manner a first distance value of an object in the surroundings. The computation unit is also configured to recognize the at least one second pulse train in the measurement signals of the detector and to obtain in this manner at least one second distance value of the object in the surroundings. The computation unit is moreover configured to determine an image point of a LIDAR image, which is associated with a certain angular zone, based on the first distance value and the at least one second distance value.

Determining an image point, a step used repeatedly herein, can have the meaning that a value or contrast of the image point is determined.

In an example, a method comprises the transmission of a first coded pulse train of laser light and the transmission of at least one second coded pulse train of laser light. The method also comprises the recognition of the first pulse train in measurement signals, in order to obtain in this manner a distance value of an object in the surroundings. The method also comprises the recognition of the at least one second pulse train in the measurement signals, in order to obtain in this manner a second distance value of the object in the surroundings. The method also comprises determining an image point of a LIDAR image based on the first distance value and the at least one second distance value.

In an example, a computer program product or a computer program comprises control instructions which can be executed by a processor. Executing the control instructions has the effect that the processor executes a method. The method comprises the transmission of a first coded pulse train of laser light and the transmission of at least one second coded pulse train of laser light. The method also comprises the recognition of the first pulse train in measurement signals, in order to obtain in this manner a distance value of an object in the surroundings. The method also comprises the recognition of the at least one second pulse train in the measurement signals, in order to obtain in this manner a second distance value of the object in the surroundings. The method also comprises determining an image point of a LIDAR image based on the first distance value and the at least one second distance value.

A device comprises a LIDAR system with at least one laser light source and a detector, wherein the LIDAR system is configured to transmit laser light and to detect reflected laser light. The device also comprises a computation unit which is configured to actuate the LIDAR system to transmit a first coded pulse train of the laser light and to transmit at least one second coded pulse train of the laser light. The computation unit is moreover configured to recognize the first pulse train in measurement signals of the detector and to obtain in this manner a first distance value of an object in the surroundings and to recognize the at least one second pulse train in the measurement signals of the detector and to obtain in this manner at least one second distance value of the object in the surroundings. The computation unit is moreover configured to determine an image point of a LIDAR image based on the first distance value and the at least one second distance value.

A method comprises the actuation of a LIDAR system, in order to emit a first coded pulse train of laser light. The method also comprises the actuation of the LIDAR system, in order to emit at least one second coded pulse train of laser light. The method also comprises the recognition of the first pulse train in measurement signals of a detector, in order to obtain in this manner a distance value of an object in the surroundings. The method also comprises the recognition of the at least one second pulse train in the measurement signals of the detector, in order to obtain in this manner a second distance value of the object in the surroundings. The method also comprises the determination of an image point of a LIDAR image based on the first distance value and the at least one second distance value.

In an example, a computer program product or computer program comprises control instructions which can be executed by a processor. Executing the control instructions has the effect that the processor executes a method. The method comprises the actuation of a LIDAR system, in order to emit a first coded pulse train of laser light. The method also comprises the actuation of the LIDAR system, in order to emit at least one second coded pulse train of laser light. The method also comprises the recognition of the first pulse train in measurement signals of a detector, in order to obtain in this manner a distance value of an object in the surroundings. The method also comprises the recognition of the at least one second pulse train in the measurement signals of the detector, in order to obtain in this manner at least one second distance value of the object in the surroundings. The method also comprises the determination of an image point of a LIDAR image based on the first distance value and the at least one second distance value.

In an example, a device comprises a laser scanner. The laser scanner at least comprises two laser light sources and a detector. The laser scanner is configured to transmit laser light into different angular zones and to detect reflected laser light. The device also comprises a computation unit which is configured to transmit a first coded pulse train of laser light of a first laser source and to transmit a second coded pulse train of laser light of a second laser source. The transmission of the first pulse train and the second pulse train occurs in an at least partially time-parallel manner. The computation unit is moreover configured to recognize the first pulse train in measurement signals of the detector and to obtain in this manner a first distance value for objects in the surroundings. The computation unit is moreover configured to recognize the second pulse train in the measurement signals and to obtain in this manner a second distance value for objects in the surroundings. The computation unit is configured to determine a first image point of a LIDAR image based on the first distance value and to determine a second image point of the LIDAR image based on the second distance value. For example, different laser light sources can emit laser light of the same frequency. By means of such techniques, the acquisition of the measurement signals for different angular zones can be multiplexed in the code space. The same detector can acquire in a time-parallel manner measurement signals for different image points. In addition, only a particularly narrow band wavelength filter need be used for the suppression of the surrounding light.

A device comprises a LIDAR system with at least two laser light sources and a detector, wherein the LIDAR system is configured to transmit laser light into different angular zones and to detect reflected laser light. The device also comprises a computation unit which is configured to actuate the LIDAR system to transmit a first coded pulse train of laser light of a first laser source and to transmit a second coded pulse train of laser light of a second laser light source, wherein the transmission of the first pulse train and the second pulse train occurs in an at least partially time-parallel manner. The computation unit is moreover configured to recognize the first pulse train in measurement signals of the detector and to obtain in this manner a first distance value for objects in the surroundings. Furthermore, the computation is configured to recognize the second pulse train in the measurement signals and to obtain in this manner a second distance value for the objects in the surroundings. The computation unit is configured furthermore to determine a first image point of a LIDAR image based on the first distance value and to determine a second image point of the LIDAR image based on the second distance value.

A method comprises the actuation of a LIDAR system, in order to transmit a first coded pulse train of laser light of a first laser light source. The method also comprises the actuation of the LIDAR system, in order to transmit a second coded pulse train of laser light of a second laser light source, wherein the transmission of the first pulse train occurs in an at least partially time-parallel manner with the transmission of the second pulse train. The method also comprises the recognition of the first pulse train in measurement signals of a detector, in order to obtain in this manner a first distance value for objects in the surroundings. The method also comprises the recognition of the second pulse train in the measurement signals of the detector, in order to obtain in this manner a second distance value for the objects in the surroundings. The method also comprises the determination of a first image point of a LIDAR image based on the first distance value. The method also comprises the determination of a second image point of a LIDAR image based on the second distance value.

In an example, a computer program product or a computer program comprises control instructions which can be executed by a processor. Executing the control instructions has the effect that the processor executes a method. The method comprises the actuation of a LIDAR system, in order to transmit a first coded pulse train of laser light of a first laser light source. The method also comprises the actuation of the LIDAR system, in order to transmit a second coded pulse train of laser light of a second laser light source, wherein the transmission of the first pulse train occurs in an at least partially time-parallel manner with the transmission of the second pulse train. The method also comprises the recognition of the first pulse train in measurement signals of a detector, in order to obtain in this manner a first distance value for objects in the surroundings. The method also comprises the recognition of the second pulse train in the measurement signals of the detector, in order to obtain in this manner a second distance value for the objects in the surroundings. The method also comprises the determination of a first image point of a LIDAR image based on the first distance value. The method also comprises the determination of a second image point of a LIDAR image based on the second distance value.

A device comprises: a LIDAR system with at least one laser light source and a detector, wherein the LIDAR system is configured to transmit laser light and to detect reflected laser light. The device also comprises a computation unit which is configured to select a coding from a plurality of coding candidates. Here, the computation unit is moreover configured to actuate the LIDAR system, in order to transmit a pulse train of the laser light, which is coded with the selected coding. The computation unit is also configured to recognize the pulse train in measurement signals of the detector and to obtain in this manner a distance value of an object in the surroundings. The computation unit is moreover configured to determine an image point of a LIDAR image based on the distance value.

A method comprises the selection of a coding from a plurality of coding candidates. The method also comprises the actuation of a LIDAR system, in order to emit a pulse train of laser light, which is coded with the selected coding. The method also comprises the recognition of the pulse train in measurement signals of a detector, in order to obtain in this manner a distance value of an object in the surroundings. The method also comprises the determination of an image point of a LIDAR image based on the distance value.

In an example, a computer program product or a computer program comprises control instructions which can be executed by a processor. Executing the control instructions has the effect that the processor executes a method. The method comprises the selection of a coding from a plurality of coding candidates. The method also comprises the actuation of a LIDAR system in order to emit a pulse train of laser light, which is coded with the selected coding. The method also comprises the recognition of the pulse train in measurement signals of a detector, in order to obtain in this manner a distance value of an object in the surroundings. The method also comprises the determination of an image point of a LIDAR image based on the distance value.

Naturally, the above-mentioned embodiments and examples can also be combined with one another in other embodiments or examples. For example, techniques for the CDMA-based extension of the range by using differently coded pulse trains in connection with a single image point could also be combined with CDMA-based techniques for avoiding interference with other LIDAR systems by an appropriate selection of the coding and/or combined for the CDMA-based increase of the lateral resolution by using differently coded pulse trains in connection with different image points.

### BRIEF DESCRIPTION OF THE FIGURES

FIG. 1 diagrammatically illustrates a device according to different embodiments with a laser scanner and a computation unit.

FIG. 2 diagrammatically illustrates the laser scanner according to different embodiments.

FIG. 3 is a flow chart of a method according to different embodiments.

FIG. 4 diagrammatically illustrates the transmission of laser light into different angular zones by means of a deflection unit of the laser scanner according to different embodiments.

FIG. 5 diagrammatically illustrates a LIDAR image with multiple image points according to different embodiments.

FIG. 6 diagrammatically illustrates a first pulse train and a second pulse train in each case with multiple pulses of the laser light according to different embodiments.

FIG. 7 diagrammatically illustrates a first pulse train and a second pulse train in each case with multiple pulses of the laser light according to different embodiments.

FIG. 8 diagrammatically illustrates a first pulse train and a second pulse train in each case with multiple pulses of the laser light according to different embodiments.

FIG. 9 diagrammatically illustrates a detector in the form of a single photon avalanche diode array detector according to different embodiments.

FIG. 10 is a flow chart of a method according to different embodiments.

FIG. 11 is a flow chart of a method according to different embodiments.

### DETAILED DESCRIPTION OF EMBODIMENTS

The above-described properties, features and advantages of this invention and the manner in which they are achieved become clearer and more understandable in connection with the following description of the embodiment examples which are explained in greater detail in connection with the drawings.

Below, the present invention is explained in greater detail based on preferred embodiments in reference to the drawings. In the figures, identical reference numerals denote identical or similar elements. The figures are diagrammatic representations of different embodiments of the invention. Elements represented in the figures are not necessarily represented true to scale. Instead, the various elements represented in the figures are reproduced in such a manner that their function and general purpose become understandable to the person skilled in the art. Connections and couplings between functional units and elements, which are represented in the figures, can also be implemented as an indirect connection or coupling. A connection or coupling can be implemented by wire or wireless means. Functional units can be implemented as hardware, software or a combination of hardware and software.

Below, various techniques are described for performing a distance measurement by means of the transit time of laser light. For this purpose, a LIDAR system is provided.

Here, it would be possible, for example, for the laser light to be scanned, i.e., emitted sequentially in different directions; the LIDAR system is then implemented by a laser scanner. However, in other examples, it would also be possible for the laser light to be emitted in a time-overlapping manner in a 1-D or 2-D surrounding area. Such techniques are sometimes also referred to as FLASH-LIDAR.

Below reference is made primarily to a laser scanner, wherein corresponding techniques can also be implemented without the scanning of light, namely, for example, by means of FLASH-LIDAR techniques.

Below, various techniques for scanning laser light are described. The techniques described below can enable, for example, the one-dimensional or two-dimensional scanning of laser light. Scanning can refer to repeated emission of laser light with different radiation angles or angular zones. The repeated implementation of a certain angular zone can determine a refresh rate of the scanning. The number of angular zones can define a scanning area or an image area. The scanning can refer to the repeated scanning of different scan points in the surroundings by means of the laser light. For each scan point, measurement signals can be determined. In the case of the FLASH-LIDAR, the light is emitted simultaneously into the image area.

For example, coherent or incoherent laser light can be used. It would be possible to use polarized or non-polarized laser light. For example, it would be possible to use the laser light in pulsed form. For example, short laser pulses with pulse lengths in the range of femtoseconds or picoseconds or nanoseconds can be used. The maximum power of individual pulses can be in the range of 50 W-150 W, in particular for pulse lengths in the range of nanoseconds. For example, a pulse duration can be in the range of 0.5-3 nanoseconds. The laser light can have wavelength in the range of 700-1800 nm. As laser light source, a solid state laser diode can be used, for example. For example, the SPL PL90_3 diode of the company OSRAM Opto Semiconductors GmbH, Leibnizstraße 4, D-93055 Regensburg or a similar solid state laser diode could be used as laser light source.

In various examples, the image area is defined one-dimensionally. This can mean, for example, that the laser scanner scans the laser light only along a single scanning axis by means of a deflection unit. A FLASH-LIDAR system can emit the laser light simultaneously along a 1-D axis. In other examples, the scanning area is defined two-dimensionally. This can mean, for example, that the laser scanner scans the laser light along a first scanning axis and along a second scanning axis by means of the deflection unit. The first scanning axis and the second scanning axis are different from one another here. For example, the first and second scanning axes can be arranged orthogonally to one another. A FLASH-LIDAR system can emit the laser light simultaneously into a 2-D image area.

In some examples, a two-dimensional image area can be implemented by a single deflection unit with two or more degrees of freedom of movement. This can mean that a first movement of the deflection unit along the first scanning axis and a second movement of the deflection unit along the second scanning axis are brought about, for example, by an actuator, wherein the first movement and the second movement are spatially and temporally superposed.

In other examples, the two-dimensional image area can be implemented by more than one deflection unit. In that case, it would be possible, for example, that a single degree of freedom of movement is given to two deflection units in each case. The laser light can first be deflected by a first deflection unit and then be deflected by a second deflection unit. The two deflection units can thus be arranged one after the other in the beam path. This means that the movements of the two deflection units are not spatially superposed. For example, a corresponding laser scanner can comprise two mirrors or prisms arranged apart from one another, each being capable of being adjusted individually.

In various embodiments, it is possible that the laser scanner operates with/different degrees of freedom of movement in a resonant manner for the scanning of the laser light. Such a laser scanner is sometimes also referred to as a resonant laser scanner. In particular, a resonant laser scanner can be different from a laser scanner which operates with least one degree of freedom of movement in a stepped manner. In some examples, it would be possible, for example, for a first movement—which corresponds to a first scanning axis—and a second movement—which corresponds to a second scanning axis different from the first scanning axis—to be brought about each in a resonant manner.

In various examples, for the scanning of the laser light, a movable end of an element in fiber form (i.e., fiber) is used as deflection unit. For example, optical fibers can be used, which are also referred to as glass fibers. However, the fibers to do not have to be produced out of glass here. The fibers can be produced, for example, out of plastic, glass, silicon or another material. For example, MEMS techniques could be used to make available fibers based on wafer technology—for example, silicon-on-insulator wafer technology. For this purpose, lithography and etching steps and grinding steps can be used. For example, the fibers can be produced from quartz glass. For example, the fibers can have a modulus of elasticity of 70 GPa or a modulus of elasticity in the range of 40 GPa-80 GPa, preferably in the 60-75 GPa range. The modulus of elasticity can be in the range of 150 GPa-200 GPa. For example, the fibers can allow a material expansion of up to 4%. In some examples, the fibers have a core in which the supplied laser light propagates and is enclosed by total reflection on the margins (fiber optic cable). However, the fiber does not have to have a core. In various examples, so-called single mode optical fibers or multimode fibers can be used. The different fibers described herein can have a circular cross section, for example. For example, it would be possible for the different fibers described herein to have a diameter which is not less than 50 μm, optionally not <150 μm, in addition optionally not <500 μm, and in addition optionally not <1 mm. However, the diameter can also be <1 mm, optionally <500 μm, in addition optionally less than 150 μm. For example, the different fibers described herein can be configured so that they can be bent or curved, i.e., so that they are flexible. For this purpose, the material of the fibers described herein can exhibit a certain elasticity.

For example, the movable end of the fibers can be moved in one or two dimensions. For example, it would be possible for the movable end of the fiber to be tilted with respect to a fastening site of the fiber; this has the effect that a curvature of the fiber. This can correspond to a first degree of freedom of movement. Alternatively or additionally, it would also be possible for the movable end of the fiber to be twisted along the fiber axis (torsion). This can correspond to a second degree of freedom of movement. In the various examples described herein, it is possible in each case to implement a torsion of the movable end of the fiber alternatively or in addition to a curvature of the movable end of the fiber. In other examples, other degrees of freedom of movement could also be implemented. Due to the movement of the movable end of the fiber, it is possible to achieve that laser light is radiated at different angles. Thereby, the surroundings can be scanned with the laser light. Depending on the amplitude of the movement of the movable end, image areas of different size can be implemented.

In various examples, on the movable end of the fiber, at least one optical element can be attached, for example, a mirror, a prism and/or a lens such as a lens with gradient index (GRIN lens). By means of the optical element, it is possible to deflect the laser light from the laser light source. For example, the mirror could be implemented by a wafer, for example, a silicon wafer, or by a glass substrate. For example, the mirror could have a thickness in the range of 0.05 μm-0.1 mm. For example, the mirror could have a thickness of approximately 500 μm. For example, the mirror could have a thickness in the range of 25 μm to 75 μm. For example, the mirror could be designed to be of square, rectangular, ellipsoid or circular in shape. For example, the mirror could have a diameter in the range of 3 mm to 10 mm, optionally 3 mm to 6 mm. The mirror could have a back-side structuring with reinforcement ribs.

In various examples, LIDAR techniques can be applied. The LIDAR techniques can be used to carry out a spatially resolved distance measurement of objects in the surroundings. For example, the LIDAR technique can comprise transit time measurements of the pulsed laser light between the movable end of the fiber, the object and a detector. Alternatively or additionally, the techniques of structured illumination could also be used.

In various examples, the LIDAR technique can be implemented in connection with a driver assistance functionality for a motor vehicle. A device containing the laser scanner can therefore be arranged in the motor vehicle. For example, a depth-resolved LIDAR image can be produced and transferred to a driver assistance system of the motor vehicle. Thus, for example, assisted driving or autonomous driving techniques can be implemented.

Various examples are based on the finding that it can be desirable in principle to reach the greatest possible measurement distance. Here, the measurement distance can be limited by the maximum power of the pulses that can be provided by a laser light source—such as, for example, a solid state laser diode. Alternatively or additionally, it would also be possible for the measurement distance to be limited by certain requirements of eye safety.

Additional examples are based on the finding that it can be desirable in principle to avoid crosstalk or interference with other LIDAR systems in the surroundings. For example, during the use of LIDAR systems in motor vehicles, the laser light emitted by a first LIDAR system of a first vehicle can be detected by a second LIDAR system of a second vehicle. Thereby, the measurement of the second vehicle is distorted. Unintended saturation of the detector of the LIDAR system can also occur, which corresponds to a “blinding” of the second LIDAR system by the first LIDAR system. It has been observed that such interferences between multiple LIDAR systems can occur in a particularly strong manner when a LIDAR system does not carry out spatial filtering: for example, in some laser scanners, it can be possible to use the emitter aperture as detector aperture. Thereby, it is possible to achieve that in each case only light from the angle into which light was also emitted—and from which a signal relevant to the distance measurement is therefore also expected—is collected. Thereby, background radiation can be suppressed. In addition, the likelihood that another LIDAR system emits laser light precisely into this angle—which would lead to interference—is lowered. However, some LIDAR systems do not use such spatial filtering but instead use a detector optics system which collects the light from a particularly large angular zone. This is the case, for example, in connection with the structured illumination or FLASH-LIDAR techniques: there, a large area of the surroundings is illuminated simultaneously and, as a result, it is also necessary to detect light from this large area of the surroundings. Moreover, the likelihood of increased interference is already increased when a first LIDAR system, for example, uses the FLASH-LIDAR technique—and thus emits laser light in an extended 1-D or 2-D image area—and a second LIDAR system uses spatial filtering: here too, the likelihood is increased that the first LIDAR system emits light precisely into the angle detected by the second LIDAR system or at least brings about reflections at this angle.

Various examples are moreover based on the finding that it can be desirable to use, instead of particularly long pulses—for example, with a pulse length in the range of 50-100 ns—a pulse train with multiple short pulses—for example, with pulse lengths in the range of 0.5-4 ns: in that case, multiple pulse edges are obtained per unit of time, whereby, overall, the measurement accuracy with which a distance value of an object in the surroundings can be determined can be increased.

Various examples are moreover based on the finding that it can be desirable to consider more than one pulse train: in this manner, multiple distance values of the object in the surroundings, associated with the different pulse trains, can be determined, whereby the measurement accuracy can in turn be increased.

Various examples are moreover based on the finding that, in the case of FLASH-LIDAR systems in accordance with reference implementations, interferences between adjacent detector image points can occur. For example, by an appropriate design of the detection optics system, a first detector image point can be associated with a first angle, and a second detector image point can be associated with a second angle. The first detector image point can be arranged adjacently to the second detector image point. When the first detector image point measures a large signal amplitude—for example, because a large amount of light is incident from the first angle—crosstalk of this large signal amplitude onto the second detector image point can occur. This distorts the measurement signal of the second detector image point.

In various examples, techniques are described below for carrying out an accurate determination of the distance values, even in the case of significant noise levels, for example, due to solar irradiation or ambient light. In addition, in various examples, techniques are described below, which can reduce interference between different laser scanners. Such techniques can be advantageous particularly in connection with the use of a corresponding device in street traffic multiple vehicles may each be equipped with the LIDAR technology.

Various examples described herein are based on the fact that, for an image point of a LIDAR image, multiple pulse trains or pulse sequences each with multiple pulses of the laser light are transmitted and received. For example, a number of two or three or four or ten pulse trains per image point can be taken into consideration. Due to the use of pulse trains, the signal-to-noise ratio can be increased, since each pulse train comprises multiple pulses. By using multiple pulse trains, the signal-to-noise ratio can be further increased, since an even larger number of pulses is used. In some examples, different pulse trains are coded differently. Thereby, it is possible to emit a second pulse train before the previously emitted first pulse train is received. In other words, it is possible that more than one individual pulse train propagates at a certain time in the environment of the device. Thereby, it is possible to implement a particularly high image refresh rate at which LIDAR images can be provided.

Additional examples are based on the fact that FLASH-LIDAR technologies are enhanced to the effect that they emit differently coded pulse trains into different angles. This enables a separation of the light reflected from different directions based on the coding. Thereby, interferences between different detector elements can be reduced, even if they are illuminated simultaneously by light that is incident from different angles.

Additional examples are based on the fact that a coding for a pulse train of laser light is appropriately selected in order to avoid interferences with other LIDAR systems. Here, for example, a random component can be taken into consideration. It would also be possible that, by means of the control data exchanged between multiple LIDAR systems, the selection of the codings occurs in a coordinated manner for the multiple LIDAR systems. Different LIDAR systems can separate the respective associated pulse trains by a different coding and thereby reduce interferences. In addition, orthogonal codings in particular can be used.

In order to be able to separate different pulse trains, it can be possible to use code multiplexing (Code Division Multiplex, CDM or Code Division Multiple Access, CDMA) techniques. For example, the codings of different pulse trains can be orthogonal to one another. Thereby, a separation of the different pulse trains can occur, in particular also in the case of unknown distances to the reflective object.

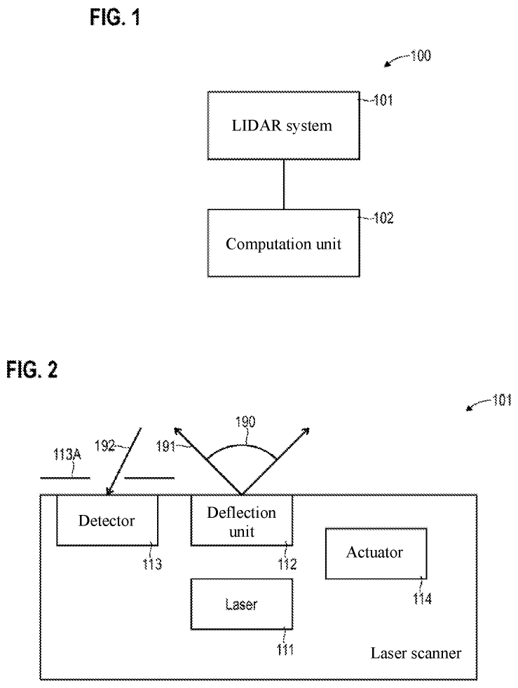

FIG. 1 illustrates aspects with regard to a device 100. The device 100 comprises a laser scanner 101. The laser scanner 101 is configured to radiate laser light from a laser light source in surroundings of the device 100. Here, the laser scanner 101 is configured to scan the laser light at least along a scanning axis. The laser scanner can, in particular, emit pulse trains of the laser light. In some examples, the laser scanner 101 is configured to scan the laser light along a first and a second scanning axis. For example, the laser scanner 101 could move a deflection unit in a resonant manner, for example, between two reversal points of the movement.

The device 100 also comprises a computation unit 102. Examples for a computation unit 102 comprise an analog circuit, a digital circuit, a microprocessor, an FPGA and/or an ASIC. The computation unit 102 can implement logics. In some examples, the device 100 can also comprise more than one computation unit implementing the logic in a distributed manner.

For example, the computation unit 102 can actuate the laser scanner 101. The computation unit 102 can set, for example, one or more operating parameters of the laser scanner 101. In the different examples herein, the computation unit 102 can activate different operating modes of the laser scanner 101. An operating mode can here be defined by a set of operating parameters of the laser scanner 101.

Examples for operating parameters comprise: the use of orthogonally or partially orthogonally or pseudo-orthogonally coded pulse trains; the number of pulses per pulse train; the envelope of the pulses of the pulse trains which can have a Gaussian shape, for example; the number of the pulse trains per image point of a LIDAR image; the length of the pulse trains; the length of individual pulses of the pulse trains; the distance between individual pulse trains; a dead time; etc.

For example, such operating parameters and others could be varied as a function of a priori knowledge of the distance to an object in the surroundings. For example, the a priori knowledge could be obtained from previous acquired LIDAR images. For example, the a priori knowledge could be obtained by sensor fusion from other environment sensors of a motor vehicle, such as, for example, an ultrasound sensor, a TOF sensor, a radar sensor and/or a stereo camera.

The computation unit 102 is moreover configured to carry out a separation or distance measurement. For this purpose, the computation unit can receive measurement signals from the laser scanner 101. These measurement signals or raw data can be indicative of a transit time of pulses of the laser light between transmission and reception. These measurement signals can moreover indicate an associated angular zone of the laser light. Based on this, the computation unit 102 can generate a LIDAR image which corresponds, for example, to a point cloud with depth information. Optionally, it would be possible for the computation unit 102 to perform, for example, an object recognition based on the LIDAR image. Then, the computation unit 102 can output the LIDAR image. The computation unit 102 can repeatedly generate new LIDAR images, for example, with an image refresh rate corresponding to the scanning frequency. The image refresh rate can be in the range of 20-100 Hz, for example.

While, in the example of FIG. 1, a scenario is illustrated in which the device 100 comprises a laser scanner 101, it would also be possible, in other examples, for the device 100 to comprise a LIDAR system operating according to another functional principle, for example, a FLASH-LIDAR system which illuminates a 1-D or 2-D image area in a time-overlapping manner based on the structured illumination. For this purpose, for example, more than one laser light source can be present.

FIG. 2 illustrates aspects with regard to the laser scanner 101. In particular, FIG. 2 illustrates a laser scanner 101 according to different examples in greater detail.

In the example of FIG. 2, the laser scanner 101 comprises a laser light source 111. For example, the laser light source 111 can be a diode laser. In some examples, the laser light source 111 can be a vertical cavity surface-emitting laser (VCSEL). The laser light source 111 emits laser light 191 which is deflected by the deflection unit 112 by a certain deflection angle. In some examples, a collimator optics system for the laser light 191 can be arranged in the beam path between the laser light source 111 and the deflection unit 112 (pre-scanner optics). In other examples, alternatively or additionally, the collimator optics system for the laser light 191 could also be arranged in the beam path behind the deflection unit 112 (post-scanner optics).

The deflection unit could comprise, for example, a mirror or a prism. For example, the deflection unit could comprise a rotating multifaceted prism. The deflection unit is in principle optional: for example, the spatial resolution could also be provided by FLASH techniques in connection with CDMA techniques, as described in further detail below.

The laser scanner 101 can implement one or more scanning axes (in FIG. 2, only one scanning axis is represented, namely in the plane of the drawing). By providing multiple scanning axes, a two-dimensional image area can be implemented.

A two-dimensional image area can make it possible to carry out the distance measurement of the object in the surroundings with greater information content. Typically, in this way, in addition to a horizontal scanning axis, a vertical scanning axis—with respect to a global coordinate system in which the motor vehicle is arranged—can be implemented. In particular, in comparison to reference implementations which achieve a vertical resolution, not by scanning, but instead by means of an array of multiple laser light sources which are offset with respect to one another and emit laser light at different angles onto a deflection unit, a less complex system having fewer components and/or a higher vertical resolution can be achieved in this manner. In addition, it can be possible in various examples to adapt corresponding operating parameters of the laser scanner 101, which are associated with the vertical scanning axis, in a flexible manner, for example, as a function of the driving state of the vehicle. In the case of a fixed installation of an array of laser light sources, this is often impossible or possible only to a limited extent.

For the scanning of the laser light 191, the deflection unit 112 has at least one degree of freedom of movement. Each degree of freedom of movement can define a corresponding scanning axis. The corresponding movement can be actuated or induced by an actuator 114.

In order to implement multiple scanning axes, it would be possible in some examples for more than one deflection unit (not represented in FIG. 2) to be present. The laser light 191 can then run sequentially through the different deflection units. Each deflection unit can have a corresponding associated degree of freedom of movement, which corresponds to an associated scanning axis. Sometimes, such an arrangement is referred to as a scanner system.

In order to implement multiple scanning axes, it would be possible, in additional examples, for the individual deflection unit 112 to comprise more than a single degree of freedom of movement. For example, the deflection unit 112 could comprise at least two degrees of freedom of movement. Corresponding movements can be induced by the actuator 114. For example, the actuator 114 can excite the corresponding movements individually, but in a time-parallel or coupled manner. Then, it would be possible to implement two or more scanning axes, by carrying out the movements with temporal or spatial overlapping.

Due to the overlapping of the first movement and the second movement in the position space and in the time space, a particularly high integration of the laser scanner 101 can be achieved. Thereby, the laser scanner 101 can be implemented with a small installation space. This allows a flexible positioning of the laser scanner 101 in the motor vehicle. In addition, it is possible to achieve that the laser scanner 101 comprises relatively few components and can therefore be produced in a robust and cost effective manner.

For example, a first degree of freedom of movement could correspond to the rotation of a mirror, and a second degree of freedom of movement could correspond to a tilting of the mirror. For example, a first degree of freedom could correspond to the rotation of a multifaceted prism, and a second degree of freedom could correspond to the tilting of the multiple facet prism. For example, a first degree of freedom could correspond to the transverse mode of a fiber, and a second degree of freedom of movement could correspond to the torsion mode of the fiber. The fiber could comprise a corresponding movable end. For example, a first degree of freedom of movement could correspond to a first transverse mode of a fiber, and a second degree of freedom of movement could correspond to a second transverse mode of the fiber, which is, for example, orthogonal to the first transverse mode.

In some examples, it is possible that both the first movement in accordance with the first degree of freedom of movement, which corresponds to a first scanning axis, and the second movement in accordance with a second degree of freedom of movement, which corresponds to a second scanning axis, are brought about in a resonant manner. In other examples, it is possible that at least one of the first movement and the second movement is not brought about in a resonant manner, but instead is operated in a discrete or stepped manner.

If both the first movement and the second movement are operated in a resonant manner, a so-called overlapping figure, sometimes also referred to as a Lissajous figure, can be obtained for the scanning along the first scanning axis and the second scanning axis. If both the first movement and the second movement are operated in a resonant manner, a particularly robust and simple system for the laser scanner can be implemented. For example, the actuator can be implemented in a simple manner.

Typically, the actuator 114 can be operated electrically. The actuator 114 could comprise magnetic components and/or piezoelectric components. For example, the actuator could comprise a rotating magnetic field source which is configured to generate a magnetic field rotating as a function of time. The actuator 114 could comprise, for example, bending piezo components.

In some examples, instead of a deflection unit 112, an array consisting of multiple emitter structures—for example, optical waveguides—, which is produced integrated on a substrate—for example, silicon—could be used, wherein the multiple emitter structures emit laser light in a certain phase relation. By varying the phase relation of the laser light which is emitted by the different emitter structures, a certain angle of radiation can be set by constructive or destructive interference. Such arrangements are also referred to sometimes as optical phased array (OPA). See M. J. R. Heck “Highly integrated optical phased arrays: photonic integrated circuits for optical beam shaping and beam steering” in Nanophotonics (2016).

The laser scanner 101 also comprises a detector 113. For example, the detector 113 can be implemented by a photodiode. For example, the detector 113 can be implemented by a photodiode array and thus comprise multiple detector elements. For example, the detector 113 can comprise one or more single photon avalanche diodes (SPAD).

The detector 113 is configured to detect secondary laser light 192 reflected by objects (not represented in FIG. 2) in the environment of the arrangement 100. Based on a measurement of the transit time between the emission of a pulse of the primary laser light 191 by the laser light source 111 and the detection of the pulse by the detector 113, a distance measurement of the objects can then be carried out. For example, such techniques could also be combined or replaced with structured illumination in which, instead of pulses of the laser light 191, continuous laser light can be used. Structured illumination here corresponds to FLASH-LIDAR techniques.

In the example of FIG. 2, the detector 113 has its own aperture 113A. In other examples, it would be possible for the detector 113 to use the same aperture which is also used for the radiation of the primary laser light 191. Then, a particularly high sensitivity can be achieved. This corresponds to a spatial filtering.

Optionally, the laser scanner 101 could also comprise a positioning device (not represented in FIG. 2). The positioning device can be configured to output a signal which is indicative of the angle of radiation at which the laser light is emitted. For this purpose, it would be possible, for example, for the positioning device to carry out a status measurement of the actuator 114 and/or of the deflection unit 112. The positioning device could also measure the primary laser light 191 directly, for example. The positioning device can in general measure the angle of radiation optically, for example, based on the primary laser light 191 and/or light of a light emitting diode. For example, the positioning device could comprise a position sensitive detector (PSD), comprising, for example, a PIN diode, a CCD array or a CMOS array. Then the primary laser light 191 and/or light from a light emitting diode can be directed via the deflection unit 112 onto the PSD, so that the angle of radiation can be measured by means of the PSD. Alternatively or additionally, the positioning device could also comprise a fiber Bragg grating, which is arranged, for example, within the fiber which forms the deflection unit 112: by a curvature and/or a torsion of the fiber, the length of the fiber Bragg grating can be changed and thereby the reflectivity for light of a certain wavelength can be changed. Thereby, the movement state of the fiber can be measured. From this, the angle of radiation can be derived.

While, in the example of FIG. 2, a scenario is represented in which the angular zone 190 is achieved by scanning of the deflection unit 112, it would also be possible, in other examples, for a structured illumination of the angular zone to be achieved by means of multiple laser light sources. No scanning is then necessary. This corresponds to FLASH-Lidar techniques.

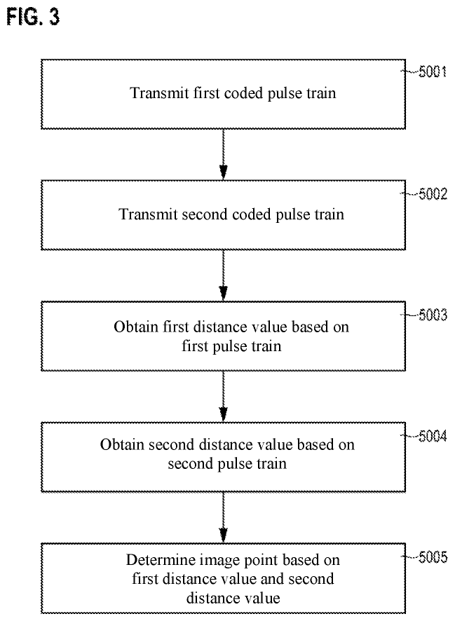

FIG. 3 is a flow chart of a method according to different examples. In block 5001, first a first pulse train comprising pulses of laser light is transmitted. For example, the first pulse train can be transmitted into an angular zone. The transmission of the first pulse train can here correspond to a certain position of the deflection unit of the laser scanner 101. The first pulse train can have a certain number of laser pulses.

The first pulse train is coded. This means that the first pulse train can comprise, for example, a binary power modulation of the pulses: a binary power modulation can mean that individual pulses have an amplitude of one (arbitrary units) and other pulses have an amplitude of zero. However, the first pulse train could also have a power modulation of higher order: here, different intermediate values of the amplitude between one (arbitrary units) and zero would be possible. The coding can mean that the modulation of the amplitude occurs according to a certain code sequence, for example, based on a spreading code. This means that the amplitudes of different pulses of the pulse train are dependent on one another via a known function. Such coding techniques can be used in the different examples described herein.

In other words, by means of the power modulation, the number of photons per pulse can be set.

By the coding of the first pulse chain, it is possible to recognize the first pulse train in measurement signals of the detector 113 in a particular reliable and accurate manner. In particular, interference with pulse trains of foreign laser scanners can be reduced, since these pulse trains can be coded differently, for example, and in particular orthogonally. From this one can already see that by an appropriate selection of the coding of an individual pulse train, the interference with foreign laser scanners can be reduced.

In block 5002, a second pulse train is transmitted. For example, the second pulse train could be transmitted into the same angular zone into which the first pulse train is also transmitted. For example, it would be possible for the first pulse train and the second pulse train to be emitted in an at least partially time-parallel manner using different laser light sources. However, it would also be possible for the first pulse train and the second pulse train to be emitted serially, wherein one and the same laser light source can be used.

In some examples, it would be possible that a time interval between the transmission of the first pulse train and of the second pulse train, i.e., between blocks 5001 and 5002, is relatively short in comparison to a rate of scanning of the deflection unit 112. This means that the deflection unit 112, between the execution of the blocks 5001 and 5002, cannot have moved further or cannot have moved significantly further. Therefore, in spite of the serial transmission of the first pulse train and of the second pulse train, it can be possible to emit both the first pulse train and also the second pulse train into the same angular zone. In this way, by means of the first pulse train and the second pulse train, redundant information concerning the distance to an object arranged in the angular zone can be obtained. Thereby, the measurement accuracy can be increased.

The first and second pulse trains from blocks 5001, 5002 can be coded according to a common coding scheme, i.e., for example, they can have the same coding type and/or the same length. For example, the first and second pulse trains could be different Walsh-Hadamard sequences of length 10. Here, the coding scheme preceding block 5001 can be selected optionally. For example, the coding scheme could be selected as a function of a driving state of a vehicle in which the LIDAR system is installed. For this purpose, various status data could be received from a vehicle computer, for example, via a vehicle bus system. The status data can be indicative of a driving state of the vehicle. For example, the status data could be indicative of one or more elements from the following group: vehicle speed; curviness of a road on which the vehicle is moving; road type of the road on which the vehicle is moving, that is to say, for example, highway, rural road and urban road; number of objects in the surroundings; ambient brightness; a criticality of the driving situation; etc. For example, depending on the criticality of the driving state, a different coding scheme could be selected. For example, depending on the road type of a road on which the vehicle is located, a different coding scheme could be selected. Typically, coding schemes with longer coding exhibit greater robustness. On the other hand, by longer/more robust codings, the workload of the laser light source can be increased. This adaptive selection of the coding scheme makes it possible to adapt the situation of balancing (i) robustness of the coding, on the one hand, against (ii) workload of the laser light source, by tailored adaptation to what is needed. For example, thereby it is possible to prevent the need to increase dead times due to an excessive workload of the laser light source, which in turn would result in a lowered image point density of the LIDAR image.

Then, in block 5003, a first distance value for an object is obtained based on the first pulse train. Block 5003 can comprise the reception of the laser light associated with a first pulse train, by means of the detector 113. In addition, block 5003 can comprise the recognition of the first pulse train in the measurement signals of the detector. For the recognition of the first pulse train in the measurement signals, CDMA techniques can be used, for example. For example, it would be possible to correlate the measurement signals with a corresponding transmission signal of the first pulse train. For a certain point in time, a maximum of the correlation can then be obtained: this maximum typically corresponds to a time when the first pulse train was received with high probability, for example, a beginning of the pulse train, the center of the pulse train, or the end of the pulse train, etc. From a comparison of the time when the first pulse train was transmitted with the time when the first pulse train was obtained, a distance value can then be determined.

In some examples, it would be possible to execute block 5002 before the detection in block 5003. This means that at a certain time, both the pulses of the first pulse train and also the pulses of the second pulse train propagate or are in-flight. Thereby, a particularly large number of pulse trains can be taken into consideration for the determination of an image point. This is possible, since, in spite of a high scanning rate of the laser scanner per image point of the LIDAR image, measurement signals for many pulse trains can be obtained. Thereby, a high measurement accuracy can be achieved. In addition, a high measurement distance can be achieved.

Then, in block 5004, a second distance value for the object is obtained based on the second pulse train. Block 5004 can comprise the reception of the laser light associated with the second pulse train. In block 5004, the second pulse train can be recognized in the measurement signals according to corresponding techniques as described above in reference to block 5003 for the first pulse train.

In some examples, it would be possible to detect the first pulse train and the second pulse train in the blocks 5003 and 5004 in an at least partially time-overlapping manner. This can mean that at least one pulse of the first pulse train is detected in a time-overlapping manner with at least one pulse of the second pulse train. Nevertheless, due to the coding of the first pulse train and of the second pulse train, it can be possible to carry out a separation of the measurement signals which belong to the first pulse train and the measurement signals which belong to the second pulse train. In this connection, in particular, it would be possible for the first coding of the first pulse train to be orthogonal to the second coding of the second pulse train. The first coding and the second coding can be implemented, for example, as a binary power modulation or a power modulation of higher order.

Finally, in block 5005 an image point of the LIDAR image is determined. The image point of the LIDAR image can be characterized by a distance of the object in the corresponding angular zone. Optionally, the image point could also indicate a speed of the object. In block 5005, the image point is determined based on the first distance value from block 5003 and based on the second distance value from block 5004. This is possible since the two distance values are associated with the same angular zone and thus with the same object. Due to the use of the first distance value and of the second distance value, a higher measurement accuracy can be achieved. For example, an average value could be computed. For example, a standard deviation could be taken into consideration as measurement inaccuracy.

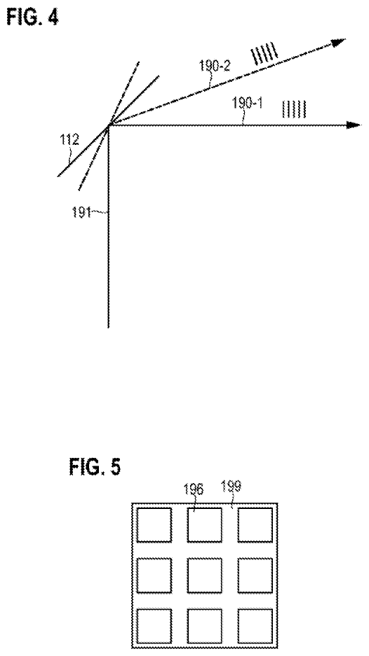

FIG. 4 illustrates aspects with regard to the laser scanner 101. In particular, FIG. 4 illustrates aspects with regard to the deflection unit 112. In the example of FIG. 4, the deflection unit 112 is implemented by a mirror. In the example of FIG. 4, it is represented how incident laser light 191 is transmitted into different angular zones 190-1, 190-2 depending on the angular position of the deflection unit 112. For example, it would be possible for the deflection unit 112 to be moved continuously. For example, the deflection unit 112 could perform a resonant movement with a certain scanning frequency. For example, the deflection unit 112 could perform a resonant movement between two reversal points.

In FIG. 4, it is furthermore illustrated diagrammatically that the laser light 191 is transmitted pulsed (series of vertical lines). In particular, in FIG. 4, it is represented that a pulse train is emitted.

FIG. 5 illustrates aspects with regard to a LIDAR image 199. The LIDAR image comprises image points 196 (in the example of FIG. 5, only nine image points 196 are represented; however, the LIDAR image could have a larger number of image points, for example, no fewer than 1000 image points or no fewer than 1,000,000 image points).

Different image points 196 of the LIDAR image 199 are associated with the different angular zones 190-1, 190-2. Each image point 196 indicates a distance value and optionally additional information.

Successive LIDAR images 199 are acquired at a certain image refresh rate. Typical image refresh rates are in the range of 5 Hz to 150 Hz.

In the different examples described herein, it is possible that the different image points 196 of a certain LIDAR image 199 are acquired with pulse trains which each have one or more identical codings. However, it would also be possible to vary the codings of the pulse trains used from image point 196 to image point 196 during the acquisition of the individual LIDAR image 199.

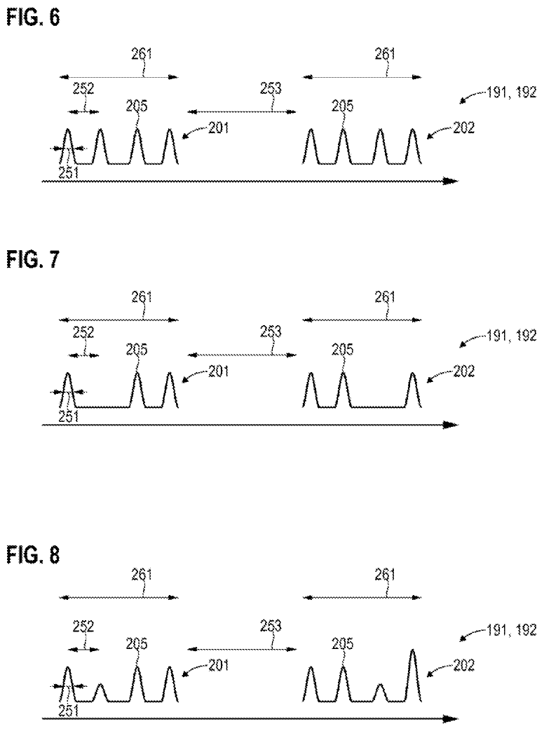

FIG. 6 illustrates aspects with regard to a pulse train 201 and an additional pulse train 202 of the laser light 191, 192. In particular, FIG. 6 illustrates aspects with regard to the timing of the pulse trains 201, 202. In the example of FIG. 6, first the pulse train 201 is transmitted. Then, the pulse train 202 is transmitted. However, it would also be possible to transmit the pulse trains 201, 202 at least partially in a time-parallel manner, for example, in that multiple laser light sources are used.

The pulses 205 have a certain length 251 (defined, for example, as the full width at half maximum of the pulses 205). In the different examples described herein, the pulses 205 of the pulse trains can have a length in the range of 200 ps to 10 ns, optionally in the range of 200 ps to 4 ns, in addition optionally in the range of 500 ps to 2 ns. Such a pulse duration can have advantages with regard to the expected number of photons in the reflected laser light 192 for typical powers of the laser light source 111 and typical measurement distances.

In the example of FIG. 6, a time interval 252 between successive pulses of the pulse train 201 is represented moreover. In the different examples described herein, the time interval 252 between successive pulses 205 can be in the range of 5 ns to 100 ns, optionally in the range of 10 ns to 50 ns, in addition optionally in the range from 20 to 30 ns. Such a time interval 252 can have advantages, in particular in connection with a cooling time of an emitter surface of a solid state laser diode.

In the example of FIG. 6, the pulse train 201 has a number of four pulses 205. In the different examples described herein, it would be possible, for example, that the pulse train 201 has a number of 2-30 pulses, optionally 8-20 pulses. Such a number of pulses has in particular has advantages with regard to a dimensioning of the length of the pulse train with regard to a speed of the deflection unit 112 or with regard to an image refresh rate at which successive LIDAR images are acquired.

For example, pulse train 201 could have a length 261 of 80 ns to 500 ns, optionally 120 ns to 200 ns: this can in general apply for the different pulse trains described herein. For example, a scanning frequency at which the deflection unit 112 is used could be in the range of 500 Hz to 2 kHz. Therefore, it can be assumed, for example, that for a time duration in the range of microseconds, the deflection unit 112 transmits laser light 191 into the same angular zone 190-1, 190-2. In the case of a correspondingly shorter dimensioning of the length 261 of the pulse train 201, it can be achieved that more than a single pulse train 201, 202 can be transmitted per angular zone 190-1, 190-2. For example, in the different examples described herein, the length 261 of the pulse trains could be no longer than 0.01% of the period duration of the scanning movement of the deflection unit 112, optionally no longer than 0.001%, in addition optionally no longer than 0.0001%. Typical period durations of the scanning movement are in the range of 1/100 Hz to ⅓ kHz, optionally in the range of 1/200 Hz to 1/500 Hz.

For example, in the example of FIG. 6, two pulse trains 201, 202 are transmitted into the same angular zone 190-1, 190-2. The pulse train 202 has a time interval 253 with respect to the pulse train 201. In some examples, the time interval 253 can be implemented relatively small, for example, of the same or at least approximately the same order of magnitude as the time interval 252. For example, the time interval 253 could be less than 50% of the length 261 of the pulse train 201, optionally less than 20%, in addition optionally less than 5%. Such an implementation has the advantage that the deflection unit 112 is not moved or is not significantly moved between the pulse trains 201, 202. However, in other examples, it would also be possible that the time interval 253 is implemented as longer, for example, more than ten times longer than the time interval 252, optionally more than a hundred times longer, in addition optionally more than 1000 times longer. In this manner, between successive pulse trains 201, 202, dead times can be provided, which have the effect that the laser light source 111 can cool longer. In addition, individual detector elements of the detector 113 can regenerate (quenching).

In FIG. 6, a scenario is represented in which the pulse trains 201, 202 are transmitted one after the other, i.e., serially. However, implementations are also possible in which the pulse trains 201, 202 are transmitted in an at least partially time-overlapping manner, for example, by different laser light sources. Thereby, the number of image points of the corresponding LIDAR image can be dimensioned to be particularly large, because different image points in quick succession can be processed. The laser light emitted by different laser light sources in an at least partially time-overlapping manner here contributes to the acquisition of distance values for the same image point—in contrast to reference implementations in which different laser light sources illuminate different surrounding regions and thereby contribute to the acquisition of distance values of different image points. Excessive workload of an individual laser light source is avoided.

FIG. 6 also illustrates aspects with regard to a duty cycle (i.e., on-time with respect to period duration) of the pulse trains 201, 202. In the example of FIG. 6, the duty cycle of the pulse trains 201, 202 is approximately 50%, since the time periods 251 and 252 are approximately the same. Such a high duty cycle can have the effect that the pulse trains 201, 202 can have a large number of pulses 205. Thereby, a high accuracy during the recognition of the pulse trains 201, 202 in the measurement signals of the detector 113 can be achieved.

In various examples, the duty cycle of the pulse trains 201, 202 could in each case be significantly higher than a duty cycle that is thermally limited for example, which the laser light source 111 can reach over a longer time period—for example, on the order of magnitude of microseconds, milliseconds or seconds. For example, it would therefore be possible that the duty cycle of the pulse trains 201, 202 is greater by a factor of ten than a duty cycle at which the laser light source 111, averaged over the time period of multiple LIDAR images, is operated, optionally by a factor of 100, in addition optionally by at least a factor of 1000.

In order to be able to nonetheless avoid damaging the laser light source 111, dead times can be provided. During the dead time, the laser light source 111 can be configured to emit no laser light 191. During the dead times, a cooling of the laser light source 111 is possible. For example, it would be possible that the dead times in each case are arranged at reversal points of the, for example, resonant movement of the deflection unit 112. For example, the dead times could be arranged between two successively acquired LIDAR images. For example, the dead times could be arranged between successive pulse trains.

FIG. 7 illustrates aspects with regard to a pulse train 201 and an additional pulse 202 of the laser light 191, 192. In particular, FIG. 7 illustrates aspects with regard to the coding of the pulse trains 201, 202.

The example of FIG. 7 here corresponds in principle to the example of FIG. 6. In the example of FIG. 7, the pulse trains 201, 202 have a binary power modulation as coding. For example, in the example of FIG. 7, the amplitude of the second pulse 205 of the pulse train 201 is equal to zero, whereas the amplitude of the third pulse 205 of the pulse train 202 is equal to 0.

In general it can be desirable that the amplitudes of the pulses 205 of the pulse trains 201, 202 are coded orthogonally to one another (not represented in FIG. 7). For this purpose, spreading sequences can be used. Examples of sequences are, for example, Gold sequences, Barker sequences, Kasami sequences, Walsh-Hadamard sequences, Zaddof-Chu sequences, etc. Here, orthogonal can also refer to a pseudo-orthogonal coding, as can be obtained, for example, by truncated Walsh-Hadamard sequences, etc. The sequence space for the coding—from which the appropriate coding is selected from a number of coding candidates—could have, for example, a cardinal number in the range of 10-100, optionally in the range of approximately 20. In general, orthogonal coding in the sense used here can also denote a partially orthogonal coding.

Due to the orthogonal coding of the different pulse trains 201, 202, it is possible to achieve that pulse trains 201, 202 detected in a time-overlapping manner—for example, due to multiple reflections—can also be recognized reliably in the measurement signals of the detector 113. Thus, it is possible to dimension the time interval 253 of successive pulse trains 201, 202 to be particularly small: in this manner it is possible, in turn, to take into consideration many pulse trains 201, 202 per image point of the LIDAR image for the determination of associated distance values. Thereby, the measurement accuracy can be increased.

FIG. 8 illustrates aspects with regard to a pulse train 201 and with regard to an additional pulse train 202 of the laser light 191, 192. In particular, FIG. 8 illustrates aspects with regard to the coding of the pulse trains 201, 202. The example of FIG. 8 here corresponds in principle to the example of FIG. 7. However, in the example of FIG. 8, no binary power modulation for the pulses 205 is used for the generation of the coding. Instead, in the example of FIG. 8, a power modulation of higher order is used: for example, in the scenario of FIG. 8, the amplitudes of the pulses 205 can assume the values of one, 0.5 and zero (arbitrary units). In addition, even higher orders of the power modulation or other intermediate values for the amplitudes of the pulses would also be conceivable.

In the examples of FIGS. 7 and 8, in each case a power modulation of the pulses 205 for the generation of the coding was described. In various examples, it would also be possible alternatively or additionally that the amplitudes and/or phase and/or the length 252 of the individual pulses 205 are modulated within the sequence 201.

In the examples of FIGS. 6-8, an implementation has been represented in which two pulse trains 201, 202 are used in order to determine distance values for a certain image point of the LIDAR image. However, in other examples, a larger number of pulse trains 201, 202 per image point could also be used, for example, a number of no fewer than four pulse trains 201, 202, optionally no fewer than eight pulse trains 201, 202, in addition optionally no fewer than twelve pulse trains 201, 202.

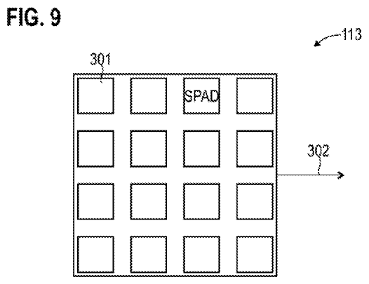

FIG. 9 illustrates aspects with regard to a detector 113. In the example of FIG. 9, the detector 113 could be configured, for example, as single photon avalanche diode detector array, i.e., SPAD. This means that the detector 113 comprises a number of detector elements 301. These detector elements 301 are arranged in a matrix pattern. The detector 113 is configured to output a measurement signal 302. The measurement signal 302 corresponds to superposed detector signals of the individual detector elements 301.

After the detection of a single photon, the different detector elements 301 can have a certain dead time for regeneration. However, due to the large number of detector elements 301—for example, no fewer than 1000, optionally no fewer than 5000, in addition optionally no fewer than 10,000—, in all cases a sufficiently large number of detector elements 301 that are ready for the detection of one or more photons can be present. Therefore, it is also possible to detect pulses 205 of multiple pulse trains 201, 202 in a time-overlapping manner or in rapid succession by means of the detector 113.

Light from the image area to be reproduced is therefore mapped by a suitable detection optics system onto the entire detector, that is to say onto all the detector elements 301. In particular, it is not necessary to provide a detector optics system which maps light incident from different angles onto different detector elements 301. For example, a first light which is incident from an angle of 0° (arbitrary coordinate system) could be mapped onto the same detector element 301, for example, as light incident at an angle of 5° or even 30° (same coordinate system). Thereby, it can be achieved that enough unsaturated detector elements 301 that are ready to detect incident photons are always present. In connection with FLASH-LIDAR techniques, a spatial resolution by CDMA techniques can occur—and not as in reference implementations—by an association of angles of incidence with detector elements.

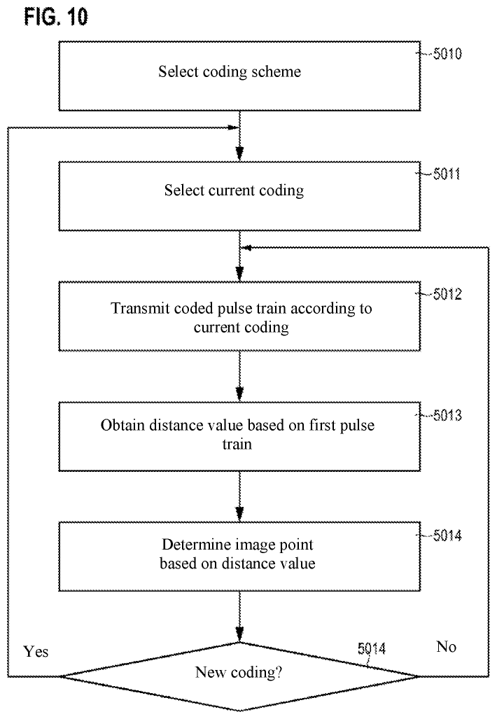

FIG. 10 illustrates aspects with regard to an exemplary method. The method according to the example of FIG. 10 makes it possible to reduce interferences between different LIDAR systems that access a common spectral range. This is enabled by CDMA techniques.

First, in block 5010, the selection of a coding scheme occurs. The coding scheme establishes which coding candidates are subsequently available in block 5011.

In general, the coding scheme can establish, for example, a coding space or sequence space, i.e., from the number of coding candidates. For example, the coding candidates can be selected from a sequence space which contains codings of the following type: Gold sequences, Barker sequences, Kasami sequences, Walsh-Hadamard sequences, Zaddof-Chu sequences. The different coding candidates can here be orthogonal to one another in pairs. Depending on the coding scheme, different types of codings can then be selected, for example, Barker sequences or Zaddof-Chu sequences. Depending on the coding scheme, codings with different length can also be selected. Typically codings of different type and/or different length exhibit a different robustness with respect to pair-wise interference. For example, it can be possible to separate two codings with length 10 more reliably than two codings with length 4.

In block 5010, different decision rules can be taken into consideration. For example, status data can be received from a vehicle computer of a vehicle. The status data can be indicative of a driving state of the vehicle. For example, the status data can be indicative of one or more elements from the following group: speed of the vehicle; curviness of a road on which the vehicle is moving; road type of the road on which the vehicle is moving, thus, for example a highway, rural road and urban road; number of objects in the surroundings; ambient brightness; criticality of the driving situation; etc.

Different driving states can here require a different robustness of the coding. For example, if, in urban traffic, numerous other LIDAR systems cause much interference, a coding system with greater robustness can be selected. Accordingly, on a highway with separate driving lanes and thus, in principle, reduced interference, a coding scheme with lower robustness could be selected. Thereby, it is possible to address the situation of balancing between workload of the laser light source, on the one hand, and reduction of interference, on the other hand, by tailored adaptation. For example, it is possible thereby to prevent the situation in which, due to an excessive workload of the laser light source, an image point density has to be reduced, in order to save the laser light source.

In principle, block 5010 is optional. It would also be possible for the coding scheme to be predetermined in a fixed manner.

In block 5011, the coding to be used is then determined from the number of coding candidates obtained from block 5010. As a general rule, during the selection in block 5011, different decision criteria can be taken into consideration individually or in combination with one another. In a simple implementation, the selection can occur with a random component. In this manner, it is possible, in the case of multiple LIDAR systems which potentially cause interference with one another, to achieve that a distribution in the sequence space reduces the interference.

In an additional implementation, control data could be transmitted and/or received (communicated) wirelessly via a radio interface. Then, the selection can occur based on the control data. In this manner, a coordinated selection of the coding can occur. For example—in an ad hoc manner—the control data could be communicated with one or more additional devices with LIDAR systems. For this purpose, for example, vehicle-to-vehicle (V2V) or in general device-to-device (D2D) communication can be used. However, it would also be possible to communicate the control data with a central coordination node, for example, with a base station or a scheduler of a radio cell network. For example, the control data could associate an identification number with each device connected with the base station; from this identification number, which can implement the control data, a rule can then be derived for the selection of the coding. By such techniques, interference can be avoided in a coordinated manner. For example, the available coding candidates could be distributed among the different participants.

In an additional implementation, status data of a vehicle in which the LIDAR system is installed could also be taken into consideration. For example—depending on whether the vehicle is on a highway or in urban traffic—a different coding, for example, of different length, etc., could be selected.

In block 5012 the pulse train coded in accordance with the currently selected coding is transmitted.

Then, a measurement signal is received, and the pulse train is recognized in the measurement signal. For this purpose, the CDMA technique can be used in order to achieve, based on a correlation with the signal shape expected on the basis of the coding, a separation with respect to pulse trains coded with another coding. In block 5013, a distance value is determined, and in block 5014, based on this distance value, the contrast of an image point of the LIDAR image is determined.

In block 5014, a verification is carried out to determine whether a new coding should be selected by renewed iteration of block 5011; or whether by direct renewed iteration of block 5012 the pulse train can be emitted directly in accordance with the current coding. Block 5014 thus enables the repeated selection of different codings—for example, according to the same coding scheme, if block 5010 is not also repeated (which would be possible, although it is represented differently in FIG. 10).

In block 5014, different decision criteria can be taken into consideration. In an example, it would be possible for a new coding to be selected at a predetermined refresh rate. For example, the refresh rate can be in the range of 1 second to 30 seconds. This is based on the finding that the typical stay of vehicles in the vicinity of one another, for example, at intersections in urban traffic, falls approximately in this time period or slightly longer. Thereby, interference can be prevented effectively.

In other examples, as decision criterion, the synchronization with the image refresh rate of the LIDAR images could occur. This means that, for example, for each n^{th} LIDAR image, the coding can be changed, where n=1, 2, 3, etc. In this manner, it is possible to prevent the situation that multiple successively acquired LIDAR images are influenced by the same type of interference. This can enable more robust evaluation algorithms on the application level (for example, object recognition, image segmentation, etc.).

Furthermore, it would also be possible to select the coding repeatedly differently, wherein a synchronization with a reference time—which a number of LIDAR systems can use—is achieved. The reference time can be derived, for example, from time synchronization data of a base station of a radio network. In this manner, on a particularly short time scale in the range of a few microseconds, the switching between different codings can occur in a coordinated manner for multiple potentially interfering LIDAR systems. This can enable a particularly efficient suppression of the interference. For example, evaluation algorithms on the application level could take into consideration the time duration of a used coding as uncertainty parameter.

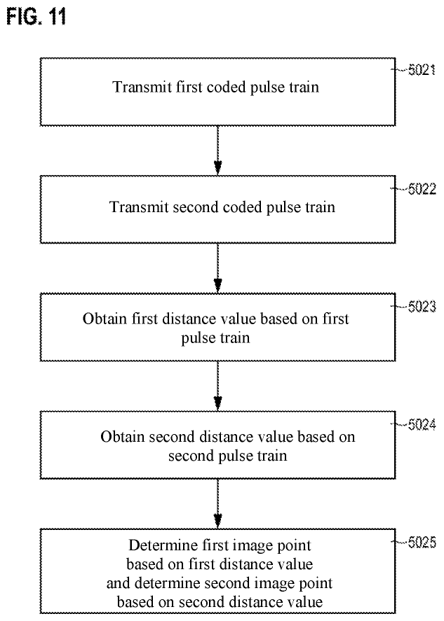

FIG. 11 is a flow chart of a method according to different examples. By means of the method according to FIG. 11, FLASH-LIDAR techniques can be enabled. In particular, a lateral resolution can be provided, in that different angles at which laser light is emitted or from which light is detected are associated with different codings.

The example of FIG. 11 here corresponds in principle to the example of FIG. 3. For example, block 5021 corresponds to block 5001. Block 5022 corresponds to block 5002. However, here, in blocks 5021 and 5022, the emission occurs into different angles, for example, angles which have an angular distance of more than 5° or more than 25°. From the corresponding angles, in blocks 5023 and 5024, photons are also detected, for example, by means of the same detector elements or by means of the same detector. By separation based on the codings, the angle from which the corresponding light originates can be derived. Then, in block 5025, based on an angle-image point association, the distance values are associated with the different points of a LIDAR image.

In the example of FIG. 11, it is not necessary to provide an association of detector elements with angles by means of an optics system. This resolution can also be achieved by CDMA techniques.

The techniques of FIG. 11 could be combined with a laser scanner. In this manner, a plurality of image points can be acquired for each position of the deflection unit. Thereby, the lateral resolution of the LIDAR image can be increased. For example, in FIG. 11, different laser light sources could be used in order to emit the pulse trains in blocks 5021, 5022; then, in an at least partially time-overlapping manner, in particular a high image point density can be enabled. However, it would also be possible that an individual laser light source sequentially emits the pulse trains from blocks 5021, 5022.

In summary, techniques have been described above, wherein the coding of pulse trains can be used in order to achieve different effects. (i) In a first scenario, by means of the coding, a higher signal-to-noise ratio for an individual image point of a LIDAR image can be obtained. For this purpose, two or more differently coded pulse trains are taken into consideration in the determination of the distance value of an individual image point. The differently coded pulse trains can be emitted in close succession by the same laser light source or even in an at least partially time-overlapping manner by multiple laser light sources. (ii) In a second scenario, by means of an appropriate coding, a lateral resolution of the LIDAR image is achieved. This means that differently coded pulse trains are emitted in different directions. By the recognition of the pulse trains in the measurement signals, it is possible to reconstruct the angles from which the corresponding light must have been incident; and thereby, the spatial resolution can be achieved. An optics system with fixed association of detector elements with angles of incidence as in conventional FLASH-LIDAR techniques is unnecessary. Such approaches can also be combined with a laser scanner in order to achieve a particularly high image point density. In some examples, a scanner is unnecessary. (iii) In a third scenario, the coding and optionally the coding scheme is/are selected in an appropriate manner in order to reduce interference with other LIDAR systems located in the environment.

In particular in connection with scenario (i), techniques have thus been described, in which a particularly high measurement accuracy for the determination of a LIDAR image by using multiple pulse trains of laser light per image point of the LIDAR image can be achieved. In order to avoid ambiguities, the different pulse trains can have an orthogonal coding. It is possible to separate the different pulse trains by CDMA techniques.

Such techniques, which are based on the use of multiple pulse trains, can be particularly desirable if the object measured is arranged at a great distance. This is the case because the intensity of the secondary laser light in such a case is relatively low and can be, for example, on the order of magnitude of the intensity of the ambient light.

In some examples, it would be possible that the use of multiple pulse trains is activated only as needed. For example, it would be possible that, based on a priori knowledge of the distance value of the object in the surroundings, as desired, multiple pulse trains are used or one or more uncoded pulses of the laser light are transmitted individually. For example, in the case of objects arranged particularly close by, a single pulse or an uncoded sequence of pulses can simply be used: in such a case, a high intensity of the reflected laser light is expected. Then, it is not necessary to use coded pulse trains.

Naturally, the features of the above-described embodiments and aspects of the invention can be combined with one another. In particular, the features can be used not only in the described combinations but also in other combinations or considered individually, without leaving the scope of the invention.

For example, techniques have been described above, wherein different pulse trains are emitted serially by laser light from a single laser light source. However, in other examples it would also be possible for different pulse trains to be transmitted in an at least partially time-overlapping manner by laser light from more than one laser light source.

For example, techniques have been described above, wherein the laser light of different pulse trains is transmitted into the same angular zone, so that redundant information on the distance of an object in the surroundings can be obtained. However, in other examples, it would also be possible that different pulse trains are transmitted in an at least partially time-overlapping manner into different angular zones. Then, information on the distance of objects in the surroundings can be obtained, which can be associated with different image points of a LIDAR image. Thereby, the acquisition of the LIDAR image can be implemented particularly rapidly. This can enable FLASH techniques in which laser light is emitted simultaneously into different angular zones.

1-30. (canceled)

31. A device, comprising:
a LIDAR system with at least one laser light source and a detector, wherein the LIDAR system is configured to transmit laser light and to detect reflected laser light, and
a computation unit which is configured to actuate the LIDAR system, to transmit a first coded pulse train of the laser light and to transmit at least one second coded pulse train of the laser light,
wherein the computation unit is moreover configured to recognize the first pulse train in measurement signals of the detector and to obtain in this manner a first distance value of an object in the surroundings and to recognize the at least one second pulse train in the measurement signals of the detector and to obtain in this manner at least one second distance value of the object in the surroundings, and
wherein the computation unit is moreover configured to determine an image point of a LIDAR image based on the first distance value and the at least one second distance value.

32. The device according to claim 31,
wherein a power modulation of the pulses of the first pulse train defines a first coding,
wherein a power modulation of the pulses of the at least one second pulse train defines at least one second coding,
wherein the first coding is orthogonal to the at least one second coding.

33. The device according to claim 31,
wherein at least one of the pulses of the first pulse train and the pulses of the at least one second pulse train has a length in the range of 500 ps to 2 ns, and
wherein a time interval between successive pulses of at least one of the first pulse train and the at least one second pulse train is in the range of 5 ns to 100 ns.

34. The device according to claim 31, wherein the device comprises one of:
at least one of the pulses of the first pulse train and the pulses of the at least one second pulse train has a length in the range of 500 ps to 2 ns, and
wherein a time interval between successive pulses of at least one of the first pulse train and the at least one second pulse train is in the range of 5 ns to 100 ns.

35. The device according to claim 31, wherein at least one of the first pulse train and the at least one second pulse train has between 2-30 pulses.

36. The device according to claim 31, wherein the duty cycle of at least one of the first pulse train and at least one second pulse train is greater by a factor of 10 than a duty cycle at which the at least one laser light source averaged over the time period of several LIDAR images is operated.

37. The device according to claim 31, wherein the computation unit is configured to actuate the LIDAR system in order to transmit the at least one second pulse train before the first pulse train is detected.

38. The device according to claim 31, wherein the computation unit is configured to actuate the LIDAR system based on a priori knowledge of the distance value of the object in the surroundings, as desired either in order to transmit the first coded pulse train of the laser light and in order to transmit the coded at least one second pulse train of the laser light, or in order to transmit at least one non-coded pulse of the laser light.

39. The device according to claim 31, wherein the computation unit is configured to select a coding scheme for a first coding for the first pulse train and for a second coding for the second pulse train from a plurality of coding scheme candidates

40. The device according to claim 39, wherein the device further comprises:
a vehicle interface which is configured to receive status data from a vehicle, and
wherein the computation unit is configured to select the coding scheme taking into consideration the status data.

41. A device, comprising:
a LIDAR system with at least two laser light sources and a detector, wherein the LIDAR system is configured to transmit laser light into different angular zones and to detect reflected laser light, and
a computation unit which is configured to actuate the LIDAR system in order to transmit a first coded pulse train of laser light of a first laser light source and in order to transmit a second coded pulse train of laser light of a second laser light source,
wherein the transmission of the first pulse train and of the second pulse train occurs in an at least partially time-parallel manner,
wherein the computation unit is moreover configured to recognize the first pulse train in measurement signals of the detector and to obtain in this manner a first distance value for objects in the surroundings,
wherein the computation unit is moreover configured to recognize the second pulse train in the measurement signals and to obtain in this manner a second distance value for the objects in the surroundings,
wherein the computation unit is moreover configured to determine a first image point of a LIDAR image based on the first distance value and to determine a second image point of the LIDAR image based on the second distance value.

42. The device according to claim 41,
wherein the transmission of the first pulse train occurs at a first angle,
wherein the transmission of the second pulse train occurs at a second angle which is different from the first angle,
wherein the LIDAR system further comprises a detector optics system which is configured to map light which is incident from the first angle onto at least one detector element of the detector and to map light which is incident from the second angle onto the at least one detector element.

43. The device according to claim 42, wherein an angular distance between the first angle and the second angle is no less than 5°.

44. A device, comprising:
a LIDAR system with at least one laser light source and a detector, wherein the LIDAR system is configured to transmit laser light and to detect reflected laser light,
a computation unit which is configured to select a coding from a plurality of coding candidates,
wherein the computation unit is moreover configured to actuate the LIDAR system in order to transmit a pulse train of the laser light, which is coded with the selected coding,
wherein the computation unit is configured to recognize the pulse train in measurement signals of the detector and to obtain in this manner a distance value of an object in the surroundings,
wherein the computation unit is moreover configured to determine an image point of a LIDAR image based on the distance value.

45. The device according to claim 44, wherein the computation unit is configured to select the coding repeatedly for the coding of multiple pulse trains emitted in a time-sequential manner.

46. The device according to claim 45, wherein the computation unit is configured to select the coding repeatedly at a refresh rate in the range of 1 second-30 seconds.

47. The device according to claim 45, wherein the computation unit is configured to select the coding repeatedly at a refresh rate which is synchronized with an image refresh rate at which multiple LIDAR images are determined.

48. The device according to claim 44, wherein the computation unit is configured to take into consideration a random component during the selection of the coding.

49. The device according to claim 44, further comprising:
a vehicle interface which is configured to obtain status data from a vehicle,
wherein the computation unit is configured to select the coding taking into consideration the status data.

50. The device according to claim 44, further comprising:
a vehicle interface which is configured to obtain status data from a vehicle,
wherein the computation unit is configured to select a coding scheme from the plurality of coding candidates taking into consideration the status data.
